(19) United States
(12) Patent Application Publication
(10) Pub. No.: US 2017/0037285 A1
(43) Pub. Date: Feb. 9, 2017

(54) ANTISTATIC ADHESIVE COMPOSITION AND POLARIZING PLATE MANUFACTURED BY USING SAME

(71) Applicant: DONGWOO FINE-CHEM CO., LTD., Jeollabuk-do (KR)

(72) Inventor: Han Young CHOI, Jeollabuk-do (KR)

(21) Appl. No.: 15/298,700

(22) Filed: Oct. 20, 2016

Related U.S. Application Data
(63) Continuation of application No. PCT/KR2015/003837, filed on Apr. 16, 2015.

(30) Foreign Application Priority Data
Apr. 24, 2014 (KR) 10-2014-0049533
Apr. 2, 2015 (KR) 10-2015-0046762

(51) Int. Cl. C09J 9/02; G02B 1/16; G02B 5/30; C08F 220/18; C09J 133/08

(52) U.S. Cl. CPC C09J 9/02; C08F 220/18; C09J 133/08; G02B 5/30; G02B 1/16; C08F 2220/1825; C08F 2800/20; C09J 2205/114; C09J 2203/318; G02F 2202/28; G02F 2202/22; G02F 1/133528

(57) ABSTRACT

An antistatic adhesive composition includes a polyalkylene glycol compound having at least one alpha-alkoxy/aryloxy-acetate group at an end of a molecule, an acryl copolymer, a cross-linking agent, and an antistatic agent. An alkylene group of the polyalkylene glycol compound has 2 to 3 carbons. The alpha-alkoxy/aryloxy-acetate group includes an alkoxy group having 1 to 10 carbon atoms or an aryloxy group having 6 to 12 carbon atoms substituted at an alpha-position of an acetate group.

### CROSS REFERENCE TO RELATED APPLICATIONS

The present application is a continuation application to International Application No. PCT/KR2015/003837, with an International Filing Date of Apr. 16, 2015, which claims the benefit of Korean Patent Applications No. 10-2014-0049533, filed on Apr. 24, 2014, and No. 10-2015-0046762, filed on Apr. 2, 2015, at the Korean Intellectual Property Office, the disclosures of which are incorporated by reference herein in their entirety.

### BACKGROUND

1. Technical Field

The present invention relates to an antistatic adhesive composition, and more particularly, to an antistatic adhesive composition with excellent durability and antistatic property, and a polarizing plate fabricated using the same.

2. Description of the Related Art

An image display device generally comprises a liquid crystal cell including liquid crystals and a polarizing plate, and the liquid crystal cell may be bonded at one surface of the polarizing plate through an adhesive layer. Additionally, in order to improve performances of the image display device, a retardation plate, a wide viewing angle compensation plate, a surface protection film, a luminance-enhancing luminance, or the like, may be attached to the polarizing plate by an adhesive.

Optical members such as a surface protection film and a polarizing plate may be formed of a plastic material to generate static electricity during friction or peeling-off. Further, when a voltage is applied to liquid crystals in the presence of remaining electrostatic charges, orientation of the liquid crystal molecules may be damaged or defects may occur in a liquid crystal panel. In order to prevent such problems as described above, various antistatic treatments are performed.

For example, at least one surfactant may be added to an adhesive, and may be transferred to an object to be bonded. However, the surfactant may be easily bled on the surface of the adhesive. In addition, if it is applied to a protection film, the object to be bonded may be contaminated.

In addition, when an antistatic agent containing polyetherpolyol and an alkaline metal salt is added to an acryl adhesive, bleeding of the antistatic agent may be caused to considerably deteriorate post-curing durability of the adhesive. If the antistatic agent is applied to the protection film, bleed-out of the antistatic agent may occur under a high temperature condition to cause a contamination of the object to be bonded.

Korean Patent Laid-Open Publication No. 2006-0128660 discloses an adhesive composition that includes an ester plasticizer having at least one ether bond in a molecule, and Korean Patent Laid-Open Publication No. 2012-0132396 discloses an adhesive composition including a polyether compound that has a polyether backbone and a reactive silyl group on at least one end thereof. However, the above compositions do not have exhibit sufficient compatibility of the antistatic agent, and thus a reduction of durability caused by bleeding-out of the antistatic agent may not be sufficiently prevented.

### SUMMARY

Accordingly, it is an aspect of the present invention to provide an adhesive composition capable of significantly improving adhesiveness and enhancing durability while maintaining desired or improved antistatic property.

The above aspect of the present invention will be achieved by the following characteristics:

(1) An adhesive composition, comprising: a polyalkylene glycol compound having at least one alpha-alkoxy/aryloxy-acetate group at an end of a molecule; an acryl copolymer; a cross-linking agent; and an antistatic agent,

wherein an alkylene group of the polyalkylene glycol compound has 2 to 3 carbons,

wherein the alpha-alkoxy/aryloxy-acetate group includes an alkoxy group having 1 to 10 carbon atoms or an aryloxy group having 6 to 12 carbon atoms substituted at an alpha-position of an acetate group.

(2) The adhesive composition according to the above (1), wherein the polyalkyleneglycol compound is represented by Formula 1 below:

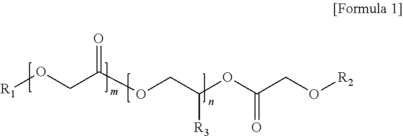

(wherein, in Formula 1, R₁ is hydrogen, an alkyl group having 1 to 10 carbon atoms or an aryl group having 6 to 12 carbon atoms, and the alkyl or aryl group is each independently and optionally substituted by an alkoxy group having 1 to 5 carbon atoms,

R₂ is an alkyl group having 1 to 10 carbon atoms or an aryl group having 6 to 12 carbon atoms, and the alkyl or aryl group is each independently and optionally substituted by an alkoxy group having 1 to 5 carbon atoms, and

R₃ is hydrogen or a methyl group, m is 0 or 1, and n is an integer of 1 to 100).

(3) The adhesive composition according to the above (2), wherein the compound represented by Formula 1 is selected from a group consisting of compounds represented by Formula 2 to Formula 6 below:

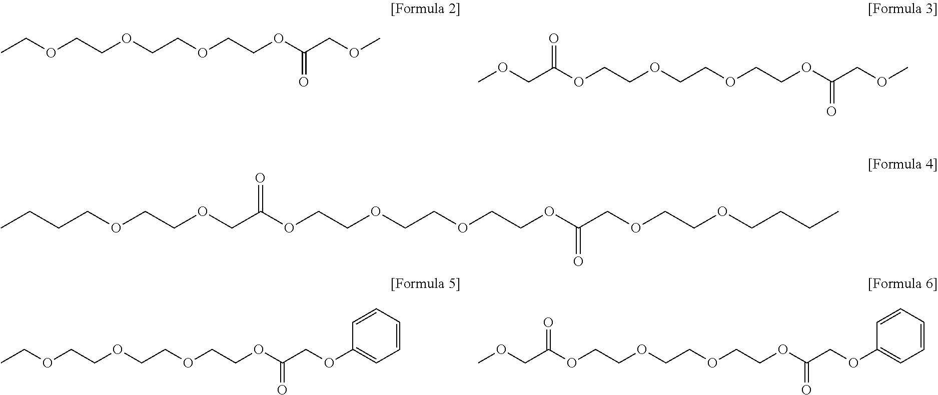

(4) The adhesive composition according to the above (1), wherein the polyalkyleneglycol compound is included in an amount of 0.1 to 10 wt. parts relative to 100 wt. parts of the acryl copolymer based on solid content.

(5) The adhesive composition according to the above (1), wherein the polyalkyleneglycol compound is included in an amount of 0.1 to 5 wt. parts relative to 100 wt. parts of the acryl copolymer based on solid content.

(6) The adhesive composition according to the above (1), wherein the antistatic agent includes an alkali metal salt of a sulfonylimide anion.

(7) An adhesive sheet comprising an adhesive layer formed using the adhesive composition according to the above (1) to (6).

(8) A polarizing plate comprising an adhesive layer formed on at least one surface thereof by using the adhesive composition according to the above (1) to (6).

(9) An image display device comprising the polarizing plate according to the above (8).

The adhesive composition according to embodiments of the present invention includes a polyalkylene glycol compound having at least one alpha-alkoxy/aryloxy-acetate group at the end of a molecule, and exhibits excellent durability due to strong polar-polar dipoles interaction, compared to the conventional ayalkyleneglycol compounds used in the art.

Also, the carbonyl group and alpha-alkoxy/aryloxy group included in the alpha-alkoxy/aryloxy-acetate group at the end of a molecule and adjacent to each other may effectively coordinate cations in an antistatic agent by a non-shared electron pair of an oxygen atom to increase a degree of ionization, thus improving antistatic property. Further, the antistatic agent may be effectively fixed to prevent bleed-out, thus remarkably improving durability of the adhesive composition.

### DETAILED DESCRIPTION

Embodiments of the present invention provides an adhesive composition with excellent durability and antistatic property, which includes an acryl copolymer, a cross-linking agent, an antistatic agent and a polyalkylene (e.g., having 2 to 3 carbon atoms) glycol compound having at least one alpha-alkoxy/aryloxy-acetate group at an end of a molecule, and a polarizing plate fabricated using the same.

<Adhesive Composition>

The adhesive composition according to embodiments of the present invention includes an acryl copolymer, a cross-linking agent, an antistatic agent, and a polyalkylene glycol compound (e.g., having 2 to 3 carbon atoms) having at least one alpha-alkoxy/aryloxy-acetate group at an end of a molecule.

Hereinafter, the present invention will be described in details.

According to example embodiments, excellent durability and antistatic property may be realized by adding a polyalkylene (having 2 to 3 carbon atoms) glycol compound having at least one alpha-alkoxy/aryloxy-acetate group at the end of a molecule.

In the descriptions provided herein, the polyalkylene (having 2 to 3 carbon atoms) glycol compound means a compound having 2 to 3 carbons atoms in an alkylene group.

The polyalkyleneglycol compound according to embodiments of the present invention may have a structure as described above, thereby enhancing durability based on strong interaction between an acryl copolymer, and an alkoxy or aryloxy-substituted acetate group at the end of a molecule, compared to a polyalkylene glycol compound typically used as an additive for conventional adhesive compositions. Further, an antistatic agent may be effectively coordinated with a non-shared electron pair of an oxygen atom contained in the alkoxy or aryloxy-substituted acetate group at the end of a molecule, so that a degree of ionization of the antistatic agent may be increased to improve antistatic property. Further, the polyalkyleneglycol compound according to embodiments of the present invention may fix the antistatic agent so that bleed-out may be prevented, thereby remarkably improving durability of the adhesive composition.

The polyalkyleneglycol compound according to embodiments of the present invention may include any compound so long as the compound has at least one acetate group described above at the end of a molecule. For example, the polyalkyleneglycol compound may be represented by Formula 1 below:

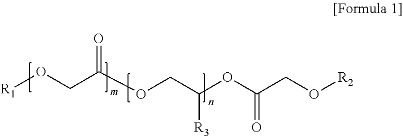

In Formula 1, R₁ may be hydrogen, an alkyl group having 1 to 10 carbon atoms, or an aryl group having 6 to 12 carbon atoms, and the alkyl or the aryl group may be each independently substituted by an alkoxy group having 1 to 5 carbon atoms. R₂ may be an alkyl group having 1 to 10 carbon atoms or an aryl group having 6 to 12 carbon atoms, and the alkyl or aryl group may be each independently substituted by an alkoxy group having 1 to 5 carbon atoms. R₃ may be hydrogen or a methyl group, m is 0 or 1, and n is an integer of 1 to 100.

In Formula 1, n may be an integer ranging from 1 to 100. For example, n may range from 1 to 10, and, particularly, n may range from 1 to 5. When n is 6 or more, the polyalkyleneglycol compound may include a reaction product of polyethyleneglycol having a molecular weight of 200, 300 and 400, respectively, or a combination thereof with 2 equivalents of alpha-methoxyacetyl chloride; or a reaction product of polyethyleneglycol methylether having a molecular weight of 550, 750, 2000 and 5000, respectively, or a combination thereof with 1 equivalent of alpha-methoxyacetyl chloride,

The compound represented by Formula 1 is not particularly limited but may include, for example, compounds represented by Formulae 2 to 6 below. When including such compounds, the durability and antistatic property of the adhesive composition may be effectively improved.

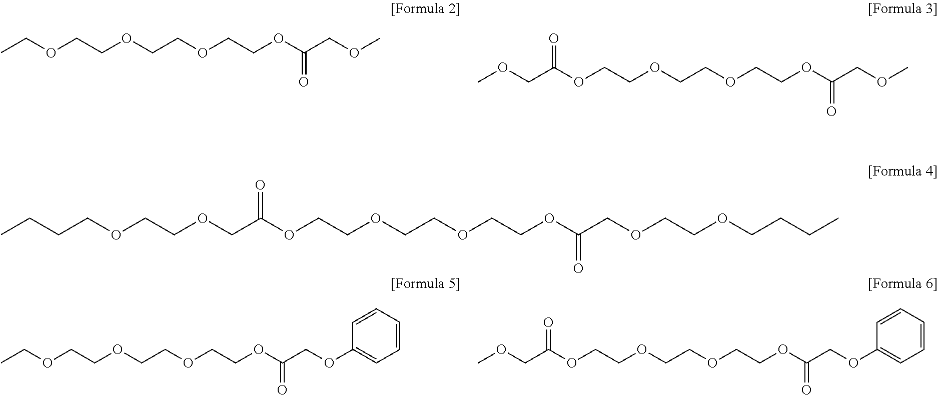

A content of the polyalkyleneglycol compound according to embodiments of the present invention is not particularly limited but, for example, may range from 0.1 to 10 wt. parts, and preferably, from 1 to 5 wt. parts relative to 100 wt. parts of an acryl copolymer based on solid content. If the content is less than about 0.1 wt. part, the durability and antistatic property may not be sufficiently improved. If the content exceeds about 10 wt. parts, adhesiveness may be decreased due to bleed-out of the polyalkyleneglycol compound to cause peel-off under heat resistant conditions, and to cause bubbles due to reduced cohesiveness.

The acryl copolymer may include any one known in the related art without particular limitation thereof.

For example, the acryl copolymer may include a compound polymerized using a (meth)acrylate monomer having an alkyl group with 1 to 12 carbon atoms and a polymerizable monomer having a cross-linkable functional group. Herein, (meth)acrylate can mean both of acrylate and methacrylate.

The (meth)acrylate monomer having an alkyl group with 1 to 12 carbon atoms may include, for example, n-butyl(meth)acrylate, 2-butyl(meth)acrylate, t-butyl(meth)acrylate, 2-ethylhexyl(meth)acrylate, ethyl(meth)acrylate, methyl(meth)acrylate, methylethyl(meth)acrylate, n-propyl(meth)acrylate, isopropyl(meth)acrylate, pentyl(meth)acrylate, n-octyl(meth)acrylate, isooctyl(meth)acrylate, nonyl(meth)acrylate, decyl(meth)acrylate, lauryl(meth)acrylate, or the like. Among these, n-butylacrylate, 2-ethylhexylacrylate or a mixture thereof may be used. These compounds may be used alone or in a combination of two or more thereof.

A content and mixing ratio of the (meth)acrylate monomer having an alkyl group with 1 to 12 carbon atoms and a mixing ratio thereof are not particularly limited but, for example, the content may range from 80 to 99 wt. parts, and preferably, from 90 to 95 wt. parts relative to 100 wt. parts of whole monomers based on solid content. If the content is less than about 80 wt. parts, adhesion may not be sufficiently achieved. When the content exceeds about 99 wt. parts, cohesiveness may be deteriorated.

The polymerizable monomer having a cross-linkable functional group may be a component for reinforcing cohesiveness or adhesive strength of the adhesive composition through a chemical bond to thus provide durability and cutting ability. For example, the polymerizable monomer may include a monomer having a carboxyl group, a monomer having a hydroxyl group, a monomer having an amide group, a monomer having a tertiary amine group, or the like. These may be used alone or in combination of two or more thereof. From an aspect of improvement in anti-corrosive property, acrylic acid may be excluded.

The monomer having a carboxyl group may include, for example: monovalent acid such as (meth)acrylic acid, crotonic acid, etc.; di-valent acid such as maleic acid, itaconic acid, fumaric acid, etc. and monoalkylester thereof; 3-(meth)acryloyl propionate; succinic anhydride ring-opening adducts of 2-hydroxyalkyl (meth)acrylate having an alkyl group with 2 or 3 carbon atoms; succinic anhydride ring-opening adducts of hydroxyalkyeleneglycol (meth)acrylate having an alkylene group with 2 to 4 carbon atoms; a compound obtained by ring-opening addition of succinic anhydride to caprolactone adduct of 2-hydroxyalkyl (meth)acrylate having an alkyl group with 2 or 3 carbon atoms, or the like. Among these, (meth)acrylic acid may be used.

The monomer having a hydroxyl group may include, for example, 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethyleneglycol (meth)acrylate, 2-hydroxypropylglycol (meth)acrylate, hydroxyalkyleneglycol (meth)acrylate having an alkylene group with 2 to 4 carbon atoms, 4-hydroxybtuyl vinylether, 5-hydroxypentyl vinylether, 6-hydroxyhexyl vinylether, 7-hydroxyheptyl vinylether, 8-hydroxyoctyl vinylether, 9-hydroxynonyl vinylether, 10-hydroxydecyl vinylether, or the like. Among these, 4-hydroxybutyl vinylether may be used.

The monomer having an amide group may include, for example, (meth)acrylamide, N-isopropyl acrylamide, N-tertiary-butyl acrylamide, 3-hydroxypropyl (meth)acrylamide, 4-hydroxybutyl (meth)acrylamide, 6-hydroxyhexyl (meth)acrylamide, 8-hydroxyoctyl (meth)acrylamide, 2-hydroxyethylhexyl (meth)acrylamide, or the like. Among these, (meth)acrylamide may be used.

The monomer having a tertiary amine group may include, for example, N,N-(dimethylamino)ethyl (meth)acrylate, N,N-(diethylamino)ethyl (meth)acrylate, N,N-(dimethylamino)propyl (meth)acrylate, or the like.

The monomer having a cross-linkable functional group may be included in an amount of 0.1 to 15 wt. parts, and, for example, 0.5 to 8 wt. parts relative to 100 wt. parts of whole monomers based on solid content. If the content thereof is less than about 0.1 wt. part, the adhesive composition may have decreased cohesiveness to reduce durability. If the content thereof exceeds about 15 wt. parts, adhesiveness may be decreased due to a high gel fraction to cause reduction in durability.

In addition to the above monomers, the acryl copolymer may further include a polymerizable monomer known in the related art within a range without causing deterioration in adhesiveness, for example, in a content of 10 wt. % or less relative to a total weight of whole monomers.

A method for preparation of a copolymer is not particularly limited, but may include conventional methods generally used in the related art, such as bulk polymerization, solution polymerization, emulsion polymerization, suspension polymerization, or the like. Solution polymerization may be used. Further, solvents, polymerization initiators, chain-transfer agents, etc., which are commonly used for polymerization, may also be used.

The acryl copolymer may have a weight average molecular weight of 50,000 to 2,000,000, and, particularly, 400,000 to 2,000,000 (in terms of polystyrene, Mw), measured by gel permeation chromatography (GPC). If the molecular weight is less than about 50,000, cohesiveness between copolymers may be insufficient to degrade adhesive durability. If the molecular weight exceeds about 2,000,000, a great amount of diluted solvent may be required in order to ensure desired workability during a coating process.

The cross-linking agent used in embodiments of the present invention may be a component for properly cross-linking the copolymer in order to reinforce cohesiveness of the adhesive composition, and may include, for example, an isocyanate-based cross-linking agent, an epoxy-based cross-linking agent, or the like, which may be used alone or in a combination of two or more thereof.

The isocyanate-based cross-linking agent may include, for example: diisocyanate compounds such as tolylene diisocyanate, xylene diisocyanate, 2,4-diphenylmethane diisocyanate, 4,4-diphenylmethane diisocyanate, hexamethylene diisocyanate, isophorone diisocyanate, tetramethylenexylene diisocyanate, naphthalene diisocyanate, etc.; adducts of a polyalcohol compound such as trimethanol propane and diisocyanate; isocyanurate obtained by self-condensation of diisocyanate; biuret body obtained by condensation of diisocyanate to diisocyanate urea; a poly-functional isocyanate compound containing three functional groups such as triphenylmethane triisocyanate, methylene bistriisocyanate, etc.

The epoxy-based cross-linking agent may include, for example: ethyleneglycol diglycidylether, diethyleneglycol diglycidylether, polyethyleneglycol diglycidylether, propyleneglycol diglycidylether, tripropyleneglycol diglycidylether, polypropyleneglycol diglycidylether, neopentylglycol diglycidylether, 1,6-hexanediol diglycidylether, polytetramethyleneglycol diglycidylether, glycerol diglycidylether, glycerol triglycidylether, diglycerol plyglycidylether, polyglycerol polyglycidylether, resorcine diglycidylether, 2,2-dibromoneopentylglycol diglycidylether, trimethylolpropane triglycidylether, pentaerythritol polyglycidylether, sorbitol polyglycidylether, diglycidylester adipate, diglycidylester phthalate, tris(glycidyl) isocyanurate, tris(glycidoxyethyl) isocyanurate, 1,3-bis(N,N-glycidylaminomethyl)cyclohexane, N,N,N′,N′-tetraglycidyl-m-xylylenediamine, or the like.

Further, at least one cross-linking agent selected from a group consisting of melamine derivatives, for example, hexamethylol melamine, hexamethoxymethyl melamine, hexabutoxymethyl melamine, or the like, may be further added to the above isocyanate-based cross-linking agent and the epoxy-based cross-linking agent.

An example of the commercially available cross-linking agent may include Cor-L (Nippon Polyurethane Industries Co.).

A content of the cross-linking agent is not particularly limited so long as it can fully express functions thereof but may include, for example, in a range of 0.1 to 15 wt. parts, and preferably, 0.1 to 5 wt. parts relative to 100 wt. parts of the acryl copolymer based on solid content. If the content thereof is less than about 0.1 wt. parts, cohesiveness decreases due to lack of cross-linking degree, and may deteriorate physical properties such as adhesive durability and cutting ability. If the content thereof exceeds about 15 wt. parts, a problem in mitigating residual stress may be caused due to excess cross-linking reaction.

Types of the antistatic agent are not particularly limited so long as those are any one generally used in the related art.

For example, cations used herein may include organic cations such as ammonium, pyridinium, imidazolium, phosphonium, sulfonium, etc., or alkali-metal cations. These may be used alone or in a combination of two or more thereof. Examples of ammonium may include a quaternary ammonium salt having four substituted alkyl groups such as tetrabutyl ammonium. Examples of pyridinium may include pyridinium having an alkyl group substituted at N of pyridine such as 1-ethyl pyridinium, 1-butyl pyridinium, 1-hexyl pyridinium, 1-butyl-3-methyl pyridinium, 1-butyl-4-methyl pyridinium, 1-hexyl-3-methyl pyridinium, 1-butyl-3-methyl pyridinium, 1-butyl-4-methyl pyridinium, 1-hexyl-3-methyl pyridinium, 1-butyl-3,4-dimethyl pyridinium or 1-octyl-4-methyl pyridinium. Examples of imidazolium may include imidazolium having an alkyl group substituted at 1,3-positions such as 1-methyl-3-butyl imidazolium, 1-methyl-3-hexyl imidazolium, etc. Examples of the phosphononium may include a quaternary phosphonium salt having four alkyl substituents such as tetrabutyl phosphonium. Examples of sulfonium may include a tertiary sulfonium salt having three alkyl substituents such as tributyl sulfonium. Examples of the alkali-metal cation may include lithium salt, sodium salt or potassium salt.

Anions may include, for example, trifluoromethane sulfonate (OTf), toluene-4-sulfonate (OTs), methane sulfonate (OMs), Cl⁻, Br⁻, I⁻, AlCl₄⁻, Al₂Cl₇⁻, BF ₄⁻, PF₆⁻, ClO₄⁻, NO₃⁻, CH₃COO⁻, CF₃COO⁻, CH₃SO₃⁻, CF₃SO₃⁻, (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃ ⁻, (C₂F₅SO₂)₂N⁻, C₃F₇COO⁻ or (CF₃SO₂) (CF₃CO)N⁻, or the like.

Among these, in consideration of durability and antistatic property, a sulfonylimide compound may be used. For example, a compound represented by Formula 7 below may be used. In Formula 7, a sulfonylimide anion may include a fluorine atom having high electronegativity to thus exhibit great stabilization effects of the anion present in a nitrogen atom, thereby achieving some advantages such as improvement in hydrophobic property of the antistatic agent to attain enhanced compatibility with acryl copolymer, no surface migration, durability reliability, and antistatic property. Therefore, the above compound may be used.

M⁺[(SO₂R)₂N]⁻ [Formula 7]

In Formula 7, M may be an alkaline metal, and R may be a fluorine atom or perfluoroalkyl group having 1 to 4 carbon atoms.

The alkaline metal may be lithium, sodium, potassium or cesium, and preferably, lithium, sodium or potassium.

The antistatic agent compound represented by Formula 7 may include, for example, bis(fluorosulfonyl)imide potassium (KN(FSO₂)₂), bis(fluorosulfonyl)imide sodium (NaN(FSO₂)₂), bis(fluorosulfonyl)imide lithium (LiN(FSO₂)₂), bis(trifluorosulfonyl)imide potassium (KN(CF3SO₂)₂), bis(trifluorosulfonyl)imide sodium (NaN(CF₃SO₂)₂) or bis(trifluorosulfonyl)imide lithium (LiN(CF3SO₂)₂), or the like, preferably bis(fluorosulfonyl)imide potassium (KN(FSO₂)₂), bis(fluorosulfonyl)imide sodium (NaN(FSO₂)₂), etc. These compounds may be used alone or in a combination of two or more thereof.

The antistatic agent commercially available in the related art may include, for example, KN(FSO₂)₂ (Mitsubishi Co.).

The antistatic agent may be included in an amount of 0.1 to 10 wt. parts, and preferably, 0.5 to 10 wt. parts relative to 100 wt. parts of the acryl copolymer based on solid content.

If the content thereof is less than about 0.1 wt. part, antistatic property may not be sufficiently obtained, and if the content thereof exceeds about 10 wt. parts, bleed-out may easily occur to cause poor exfoliation under heat resistant conditions.

The adhesive composition according to embodiments of the present invention may further include a silane coupling agent. The silane coupling agent may be added to improve adhesion to an adhesive, and may not be particularly limited so long as it contains a functional group such as amino, epoxy, acetoacetyl, polyalkyleneglycol, acryl, alkyl, etc. For example, vinyl trimethoxysilane, vinyl triethoxysilane, vinyl tris(2-methoxyethoxy)silane, N-(2-aminoethyl)-3-aminopropylmethyl dimethoxysilane, N-(2-aminoethyl)-3-aminopropyl trimethoxysilane, 3-aminopropyl triethoxysilane, 3-glycidoxypropyl trimethoxysilane, 3-glycidoxypropylmethyl dimethoxysilane, 2-(3,4-epoxycyclohexyl)ethyl trimethoxysilane, 3-chloropropylmethoxyl dimethoxysilane, 3-chloropropyl trimethoxysialne, 3-methacryloxypropyl trimethoxysialne, 3-mercaptopropyl trimethoxysilane, 3-glycidoxypropyl triethoxysilane, 3-glycidoxypropyl dimethoxymethylsilane, 3-glycidoxypropyl ethoxydimethylsilane, or the like. These compounds may be used alone or in a combination of two or more thereof.

The silane coupling agent commercially available in the related art may include, for example, KBM-403 (Shinetsu Co.).

A content of the silane coupling agent is not particularly limited but may be included, for example, in an amount of 0.1 to 2 wt. parts, and preferably, 0.1 to 0.5 wt. part relative to 100 wt. parts of the acryl copolymer, based on solid content. If the content thereof is less than about 0.1 wt. part, adhesion to a substrate may not be sufficient to cause exfoliation under heat and moist resistant conditions. If the content thereof exceeds about 2 wt. parts, cohesiveness may be excessively increased to degrade adhesive properties such as adhesiveness, and thus to cause reduction in durability.

The adhesive composition according to embodiments of the present invention may further include different additives generally used in the related art, e.g., an antioxidant, a leveling agent, a surface lubricant, a dye, a pigment, a light stabilizers, an anti-corrosive agent, a defoaming agent, a filler, antistatic agents, etc., within a range not departing from the purpose of the present invention.

<Adhesive Sheet>

In addition, the present invention provides an adhesive sheet including an adhesive layer formed using the adhesive composition described above.

A thickness of the adhesive layer is not particularly limited but, for example, may range from 3 to 100 μm, and preferably, from 10 to 100 μm.

The adhesive sheet according to embodiments of the present invention may include an adhesive layer formed on at least one surface of a release film.

The adhesive layer may be formed by coating at least one surface of a release film with the adhesive composition described above. A coating method is not particularly limited but may include any conventional method known in the related art. For example, bar coater, air knife, gravure, reverse roll, kiss roll, spray, blade, die coater, casting, spin coating, or the like may be employed.

The release film is not particularly limited but may include any release film commonly used for an adhesive film. For example, the release film may be formed using: polyester resin such as polyethylene terephthalate, polybutylene terephthalate, polyethylene naphthalate, polybutylene naphthalate, etc.; a polyimide resin; acryl resin; styrene resin such as polystyrene, acrylonitrile-styrene, etc.; polycarbonate resin; polylactic acid resin; polyurethane resin; polyolefin resin such as polyethylene, polypropylene, ethylene-propylene copolymer, etc.; vinyl resin such as polyvinyl chloride, polyvinylidene chloride, etc.; polyamide resin; sulfone resin; polyether-etherketone resin; allylate resin; or a mixture of the above resins.

A thickness of the release film is not particularly limited but, for example, may range from 5 to 500 μm, and preferably, from 10 to 100 μm.

<Polarizing Plate>

The present invention provides a polarizing plate including an adhesive layer formed on at least one surface thereof by using the adhesive composition described above.

The polarizing plate according to embodiments of the present invention may include a polarizer, a protective film adhered to at least one surface of the polarizer, and an adhesive layer formed of the adhesive composition on the protective film.

The polarizer may be any conventional polarizer known in the related art and, for example, prepared using a polyvinyl alcohol film by a series of processes including swelling, dyeing, cross-linking, drawing, washing, drying, etc.

The protection film is not particularly limited so long as it has excellent transparency, mechanical strength, thermal stability, moisture-shielding property, isotropic property, etc. For example, a polyester film such as polyethylene terephthalate, polyethylene isophthalate, polybutylene terephthalate, etc.; a cellulose film such as diacetyl cellulose, triacetyl cellulose, etc.; a polycarbonate film; an acryl film such as polymethyl (meth)acrylate, polyethyl (meth)acrylate, etc.; a styrene film such as polystyrene, acrylonitrile-styrene copolymer, etc.; a polyolefine film; a vinyl chloride film; a polyamide film such as nylon, aromatic polyamide, etc.; an imide film; a sulfone film; a polyetherketone film; a polyphenylene sulfide film; a vinyl alcohol film; a vinylidene chloride film; a vinyl butyral film; an allylate film; a polyoxymethylene film; an urethane film; an epoxy film; a silicon film, or the like, may be exemplified. Among these, in consideration of polarizing characteristics or durability, a cellulose film having a surface saponified by an alkali or the like, may be preferably used. The protective film may also serve as an optical layer.

The adhesive layer may be directly applied to the protection film or, formed by attaching the adhesive sheet to the protection film.

<Image Display Device>

Further, the present invention provides an image display device including the polarizing plate described above.

The image display device according to embodiments of the present invention may further include elements and constructions well known in the related art in addition to the above polarizing plate.

Hereinafter, exemplary embodiments of the present invention will be given for more concretely understanding the present invention, however, the following examples and experimental examples are proposed only for illustrating the present invention but not restricting the appended claims. Therefore, it will be obviously understood by those skilled in the art that various alterations and modifications of these examples are possible within the scope and technical spirits of the present invention, and such alterations and modifications are duly included in the range of the appended claims.

### PREPARATION EXAMPLE

### Preparation of Acryl Copolymer

A monomer mixture including 90 wt. parts of n-butyl acrylate, 8 wt. parts of methacrylate, 1 wt. part of 4-hydroxybutyl acrylate and 1 wt. part of acrylic acid was introduced into 1 L reactor equipped with a cooler for easy control of a temperature while refluxing a nitrogen gas, followed by introduction of 100 wt. parts of ethyl acetate as a solvent. Then, after purging a nitrogen gas for 1 hour to remove oxygen, the reactor was kept at 62° C. After uniformly admixing the mixture, 0.07 wt. part of azo-bis-isobutyronitrile (AIBN) was introduced, followed by reacting the same for 6 hours to prepare an acryl copolymer having a weight average molecular weight of about 1,000,000.

### EXAMPLE AND COMPARATIVE EXAMPLE

(1) Preparation of Adhesive Composition

Each of the adhesive compositions having different contents and constitutional compositions listed in Table 1 below was prepared.

(2) Formation of Adhesive Sheet

After preparing the adhesive composition described above, it was applied to a film coated with a silicon release agent, followed by drying it at 100° C. for 1 minute to form an adhesive layer having a thickness of 25 μm.

Thereafter, a release film was laminated on the adhesive layer to thus form an adhesive sheet.

(3) Fabrication of Adhesive-Bonded Polarizing Plate

After peeling off the release film from the produced adhesive sheet, an adhesive layer was laminated on an iodine polarizing plate including a TAC protection film having a thickness of 185 μm to obtain an adhesive-bonded polarizing plate. The fabricated polarizing plate was maintained for 7 days under conditions of 23° C. and 60% RH.

TABLE 1

| | | | | Cross- | Silane | |
|---|---|---|---|---|---|---|
| | Polyalkylenegly | | Acryl | linking | coupling | Antistatic |
| Section | col compound | | copolymer | agent | agent | agent |
| (wt. part) | (A) | | (B) | (C) | (D) | (E) |
| Example 1 | A-1 | 2 | 100 | 1 | 0.5 | 1 |
| Example 2 | A-2 | 1.5 | 100 | 1 | 0.5 | 1 |
| Example 3 | A-3 | 2 | 100 | 1 | 0.5 | 1 |
| Example 4 | A-3 | 5.5 | 100 | 1 | 0.5 | 1 |
| Example 5 | A-3 | 10.5 | 100 | 1 | 0.5 | 1 |
| Example 6 | A-4 | 2 | 100 | 1 | 0.5 | 1 |
| Example 7 | A-5 | 2 | 100 | 1 | 0.5 | 1 |
| Comparative | — | — | 100 | 1 | 0.5 | 1 |
| Example 1 | | | | | | |
| Comparative | A-6 | 2 | 100 | 1 | 0.5 | 1 |
| Example 2 | | | | | | |
| Comparative | A-7 | 2 | 100 | 1 | 0.5 | 1 |
| Example 3 | | | | | | |
| Comparative | A-8 | 2 | 100 | 1 | 0.5 | 1 |
| Example 4 | | | | | | |
| Comparative | A-9 | 2 | 100 | 1 | 0.5 | 1 |
| Example 5 | | | | | | |

| | |
|---|---|
| 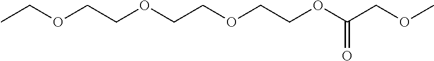 [SMILES: CCOCCOCCOCCOC(=O)COC] | A-1 |
| 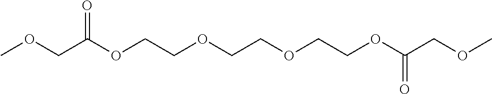 | A-2 |
| 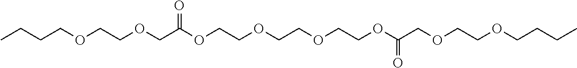 [SMILES: CCCCOCCOCC(=O)OCCOCCOCCOC(=O)COCCOCCCC] | A-3 |
| 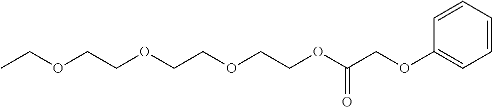 [SMILES: CCOCCOCCOCCOC(=O)COc1ccccc1] | A-4 |
| 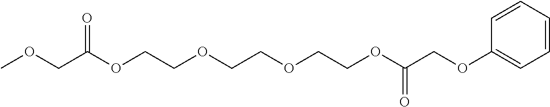 [SMILES: COCC(=O)OCCOCCOCCOC(=O)COc1ccccc1] | A-5 |
| 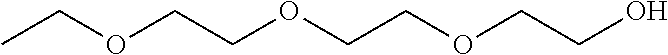 | A-6 |
| (TCI Co., triethyleneglycol monoethylether) | |
| 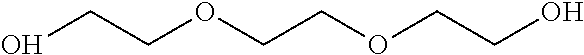 | A-7 |
| (TCI Co., triethyleneglycol) | |
| 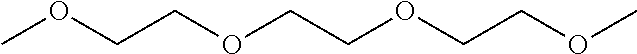 | A-8 |
| (TCI Co., triethyleneglycol dimethylether) | |
| 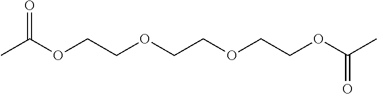 [SMILES: CC(=O)OCCOCCOCCOC(C)=O] | A-9 |

B: Acryl copolymer according to Preparation Examples
C: Cor-L (Nippon Urethane Co.: Tolylene diisocyanate trimethylolpropane adduct)
D: KBM-403(Shinetsu Co.: Glycidoxypropyl trimethoxysilane)
E: KN(FSO₂)₂ (Mitsubishi Co.: Bis(fluorosulfonyl)imide potassium)

### EXPERIMENTAL EXAMPLE

(1) Assessment of Antistatic Property

A surface resistivity of the fabricated polarizing plate was measured (unit: Ω.cm).

(2) Assessment of Heat Resistance

After removing the release film from the fabricated polarizing plate, the polarizing plate was bonded to a corning glass, followed by autoclave treatment. Then, after leaving the treated product at 60° C. for 300 hours, an occurrence of bubbles or exfoliation was observed and evaluated.

×: bubbling or exfoliation was clearly observed and visibly recognized

Δ: bubbling or exfoliation was recognized but dimly visible

ο: bubbling or dimly was not visibly recognized

TABLE 2

| Section | Antistatic property | Heat resistance |
|---|---|---|
| Example 1 | 4 × 10¹⁰ | ◯ |
| Example 2 | 4 × 10¹⁰ | ◯ |
| Example 3 | 3 × 10¹⁰ | ◯ |
| Example 4 | 1 × 10¹⁰ | ◯ |
| Example 5 | 7 × 10⁹ | Δ |
| Example 6 | 5 × 10¹⁰ | ◯ |
| Example 7 | 4 × 10¹⁰ | ◯ |
| Comparative Example 1 | 1 × 10¹¹ | X |
| Comparative Example 2 | 6 × 10¹⁰ | X |
| Comparative Example 3 | 6 × 10¹⁰ | X |
| Comparative Example 4 | 4 × 10¹⁰ | X |
| Comparative Example 5 | 4 × 10¹⁰ | Δ |

Referring to Table 2, it can be seen that the adhesive composition including a polyalkyleneglycol compound according to embodiments of the present invention exhibited high heat resistance, therefore, may not be easily peeled-off even under high temperature and high humidity conditions, while achieving excellent antistatic property.

Meanwhile, in the case of Example 5 including an excess of polyalkyleneglycol compound according to embodiments of the present invention demonstrated a slightly reduced heat resistance while having an improved antistatic property.

However, comparative examples generally showed insignificant improvement in antistatic property and considerably decreased heat resistance. In particular, Comparative Example 1 showed much lower antistatic property than those of Comparative Examples 2 to 4.

What is claimed is:

1. An adhesive composition, comprising:
a polyalkylene glycol compound having at least one of an alpha-alkoxy-acetate group or an alpha-aryloxy-acetate group at an end of a molecule;
an acryl copolymer;
a cross-linking agent; and
an antistatic agent,
wherein an alkylene group of the polyalkylene glycol compound has 2 to 3 carbons; and
said at least one of the alpha-alkoxy-acetate group or the alpha-aryloxy-acetate group includes an alkoxy group having 1 to 10 carbon atoms or an aryloxy group having 6 to 12 carbon atoms substituted at an alpha-position of an acetate group.

2. The adhesive composition according to claim 1, wherein the polyalkyleneglycol compound is represented by Formula 1 below: 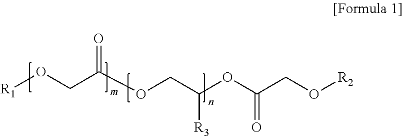
wherein, in Formula 1, R₁ is hydrogen, an alkyl group having 1 to 10 carbon atoms or an aryl group having 6 to 12 carbon atoms, and the alkyl group or the aryl group is each independently and optionally substituted by an alkoxy group having 1 to 5 carbon atoms;
R₂ is an alkyl group having 1 to 10 carbon atoms or an aryl group having 6 to 12 carbon atoms, and the alkyl group or the aryl group is each independently and optionally substituted by an alkoxy group having 1 to 5 carbon atoms;
R₃ is hydrogen or a methyl group;
m is 0 or 1; and
n is an integer of 1 to 100.

3. The adhesive composition according to claim 2, wherein the compound represented by Formula 1 is selected from the group consisting of compounds represented by Formula 2 to Formula 6:

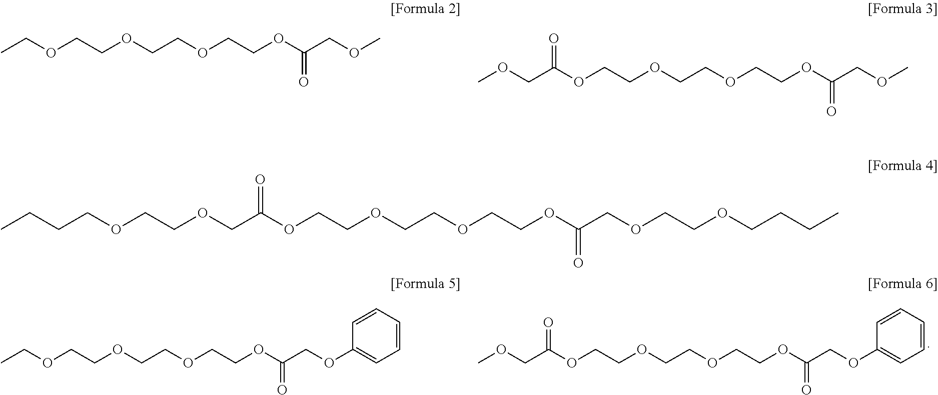

4. The adhesive composition according to claim 1, wherein the polyalkyleneglycol compound is included in an amount of 0.1 to 10 wt. parts relative to 100 wt. parts of the acryl copolymer based on solid content.

5. The adhesive composition according to claim 1, wherein the polyalkyleneglycol compound is included in an amount of 0.1 to 5 wt. parts relative to 100 wt. parts of the acryl copolymer based on solid content.

6. The adhesive composition according to claim 1, wherein the antistatic agent includes an alkali metal salt of a sulfonylimide anion.

7. An adhesive sheet comprising an adhesive layer formed using the adhesive composition according to claim 1.

8. A polarizing plate comprising an adhesive layer formed on at least one surface thereof by using the adhesive composition according to claim 1.

9. An image display device comprising the polarizing plate according to claim 8.
